(19) United States
(12) Patent Application Publication
(10) Pub. No.: US 2010/0083109 A1
(43) Pub. Date: Apr. 1, 2010

(54) METHOD FOR HANDLING INTERACTIONS WITH MULTIPLE USERS OF AN INTERACTIVE INPUT SYSTEM, AND INTERACTIVE INPUT SYSTEM EXECUTING THE METHOD

(75) Inventors: Edward Tse, Calgary (CA); Erik Benner, Cochrane (CA); Patrick Weinmayr, Calgary (CA); Peter Christian Lortz, Calgary (CA); Jenna Pipchuck, Calgary (CA); Taco van Ieperen, Calgary (CA); Kathryn Rounding, Calgary (CA); Viktor Antonyuk, Calgary (CA)

Correspondence Address: KATTEN MUCHIN ROSENMAN LLP;(C/O PATENT ADMINISTRATOR), 2900 K STREET NW, SUITE 200, WASHINGTON, DC, 20007-5118, US

(73) Assignee: SMART Technologies ULC, Calgary (CA)

(21) Appl. No.: 12/241,030

(22) Filed: Sep. 29, 2008

(51) Int. Cl. G06F 3/01; G06F 3/00

(52) U.S. Cl. 715/702; 715/755

(57) ABSTRACT

A method for handling a user request in a multi-user interactive input system comprises receiving a user request to perform an action from one user area defined on a display surface of the interactive input system and prompting for input from at least one other user via at least one other user area. In the event that input concurring with the user request is received from another user area, the action is performed.

### FIELD OF THE INVENTION

The present invention relates generally to interactive input systems and in particular to a method for handling interactions with multiple users of an interactive input system, and to an interactive input system executing the method.

### BACKGROUND OF THE INVENTION

Interactive input systems that allow users to inject input (i.e., digital ink, mouse events, etc.) into an application program using an active pointer (e.g., a pointer that emits light, sound or other signal), a passive pointer (e.g., a finger, cylinder or other suitable object) or other suitable input device such as for example, a mouse or trackball, are known. These interactive input systems include but are not limited to: touch systems comprising touch panels employing analog resistive or machine vision technology to register pointer input such as those disclosed in U.S. Pat. Nos. 5,448,263; 6,141,000; 6,337,681; 6,747,636; 6,803,906; 7,232,986; 7,236,162; and 7,274,356 assigned to SMART Technologies ULC of Calgary, Alberta, Canada, assignee of the subject application, the contents of which are incorporated by reference; touch systems comprising touch panels employing electromagnetic, capacitive, acoustic or other technologies to register pointer input; tablet personal computers (PCs); laptop PCs; personal digital assistants (PDAs); and other similar devices.

Multi-touch interactive input systems that receive and process input from multiple pointers using machine vision are also known. One such type of multi-touch interactive input system exploits the well-known optical phenomenon of frustrated total internal reflection (FTIR). According to the general principles of FTIR, the total internal reflection (TIR) of light traveling through an optical waveguide is frustrated when an object such as a pointer touches the waveguide surface, due to a change in the index of refraction of the waveguide, causing some light to escape from the touch point. In a multi-touch interactive input system, the machine vision system captures images including the point(s) of escaped light, and processes the images to identify the position of the pointers on the waveguide surface based on the point(s) of escaped light for use as input to application programs. One example of an FTIR multi-touch interactive input system is disclosed in United States Patent Application Publication No. 2008/0029691 to Han.

In an environment in which multiple users are coincidentally interacting with an interactive input system, such as during a classroom or brainstorming session, it is required to provide users a method and interface to access a set of common tools. U.S. Pat. No. 7,327,376 to Shen, et al., the content of which is incorporated herein by reference in its entirety, discloses a user interface that displays one control panel for each of a plurality of users. However, displaying multiple control panels may consume significant amounts of display screen space, and limit the number of other graphic objects that can be displayed.

Also, in a multi-user environment, one user's action may lead to a global effect, commonly referred to as a global action. A major problem in user collaboration is that a user's global action may conflict with other user's actions. For example, a user may close a window that other users are still interacting with or viewing, or a user may enlarge a graphic object causing other user's graphic objects to be occluded.

U.S. Patent Application Publication No. 2005/0183035 to Ringel, et al., the content of which is incorporated herein by reference in its entirety, discloses a set of general rules to regulate user collaboration and solve the conflict of global actions including, for example, by setting up a privilege hierarchy for users and global actions such that a user must have enough privilege to execute a certain global action, allowing a global action to be executed only when none of the users have an “active” item, are currently touching the surface anywhere, or are touching an active item; and voting on global actions. However, this reference does not address how these rules are implemented.

Lockout mechanisms have been used in mechanical devices (e.g., passenger window controls) and computers (e.g., internet kiosks that lock activity until a fee is paid) for quite some time. In such situations control is given to a single individual (the super-user). However, such a method is ineffective if the goal of collaborating over a shared display is to maintain equal rights for participants.

Researchers in the Human-computer interaction (HCI) community have looked at supporting collaborative lockout mechanisms. For example, Streitz, et al., in “i-LAND: an interactive landscape for creativity and innovation,” Proceedings of CHI '99, 120-127, the content of which is incorporated herein by reference in its entirety, proposed that participants could transfer items between different personal devices by moving and rotating items towards the personal space of another user.

Morris in the publication entitled “Supporting Effective Interaction with Tabletop Groupware,” Ph.D. Dissertation, Stanford University, April 2006, the content of which is incorporated herein by reference in its entirety, develops interaction techniques for tabletop devices using explicit lockout mechanisms that encourage discussion with global actions by using a touch technology that could identify which user was which. For example, all participants have to hold hands and touch in the middle of the display to exit the application. Studies have shown such a method to be effective for mitigating the disruptive effects of global actions for children collaborating with Aspergers syndrome; see “SIDES: A Cooperative Tabletop Computer Game for Social Skills Development,” by Piper, et al., in Proceedings of CSCW 2006, 1-10, the content of which is incorporated herein by reference in its entirety. However, because most existing touch technologies do not support user identification, Morris' techniques cannot be used therewith.

It is therefore an object of the present invention to provide a novel method of handling interactions with multiple users in an interactive input system, and a novel interactive input system executing the method.

### SUMMARY OF THE INVENTION

According to one aspect there is provided a method for handling a user request in a multi-user interactive input system comprising the steps of:
in response to receiving a user request to perform an action from one user area defined on a display surface of the interactive input system, prompting for input via at least one other user area on the display surface; and
in the event that input concurring with the request is received via the at least one other user area, performing the action.

According to another aspect there is provided a method for handling user input in a multi-user interactive input system comprising steps of:
displaying a graphical object indicative of a question having a single correct answer on a display surface of the interactive input system;
displaying multiple answer choices to the question on at least two user areas defined on the display surface;
receiving at least one selection of a choice from one of the at least two user areas;
determining whether the at least one selected choice is the single correct answer; and
providing user feedback in accordance with the determining.

According to another aspect there is provided a method for handling user input in a multi-user interactive input system comprising steps of:
displaying on a display surface of the interactive input system a plurality of graphic objects each having a predetermined relationship with at least one respective area defined on the display surface; and
providing user feedback upon movement of one or more graphic objects to at least one respective area.

According to another aspect there is provided a method handling user input in a multi-user interactive input system comprising steps of:
displaying on a display surface of the interactive input system a plurality of graphic objects each having a predetermined relationship with at least one other graphic object; and
providing user feedback upon the placement by the more than one user of the graphical objects in proximity to the at least one other graphic object.

According to a yet further aspect there is provided a method of handling user input in a multi-touch interactive input system comprising steps of:
displaying a first graphic object on a display surface of the interactive input system;
displaying multiple graphic objects having a predetermined position within the first graphic object; and
providing user feedback upon placement of the multiple graphic objects, by at least one user, within the first graphic object at the predetermined position.

According to a still further aspect there is provided a method of managing user input in a multi-touch interactive input system comprising steps of:
displaying at least one graphic object in at least one user area defined on a display surface of the interactive input system; and
in response to user interactions with the at least one graphic object, limiting the interactions with the at least one graphic object to the at least one user area.

According to a yet further aspect there is provided a method of managing user input in a multi-touch interactive input system comprising steps of:
displaying at least one graphic objects on a touch table of the interactive input system; and
in the event that at least one graphic object is selected by one user, preventing at least one other user from selecting the at least one graphic object for a predetermined time period.

According to an even further aspect there is provided a computer readable medium embodying a computer program for handling a user request in a multi-user interactive input system, the computer program code comprising:
program code for receiving a user request to perform an action from one user area defined on a display surface of the interactive input system;
program code for prompting for input via at least one other user area on the display surface in response to receiving the user request; and
program code for performing the action in the event that the concurring input is received.

According to still another aspect a computer readable medium is provided embodying a computer program for handling user input in a multi-touch interactive input system, the computer program code comprising:
program code for displaying a graphical object indicative of a question having a single correct answer on a display surface of the interactive input system;
program code for displaying multiple possible answers to the question on at least two user areas defined on the display surface;
program code for receiving at least one selection of a possible answer from one of the at least two user areas;
program code for determining whether the at least one selection is the single correct answer; and
program code for providing user feedback in accordance with the determining.

According to another aspect, there is provided a computer readable medium embodying a computer program for handling user input in a multi-touch interactive input system, the computer program code comprising:
program code for displaying on a display surface of the interactive input system a plurality of graphic objects each having a predetermined relationship with at least one respective area defined on the display surface; and
program code for providing user feedback upon movement of one or more graphic objects by the more than one user within the at least one respective area.

According to another aspect, there is provided a computer readable medium embodying a computer program for handling user input in a multi-user interactive input system, the computer program code comprising:
program code for displaying on a display surface of the interactive input system a plurality of graphic objects each having a predetermined relationship with at least one other graphic object; and
program code for providing user feedback upon the placement by the more than one user of the graphical objects in proximity to the at least one other graphic object.

According to yet another aspect there is provided a computer readable medium embodying a computer program for handling user input in a multi-user interactive input system, the computer program code comprising:
program code for displaying a first graphic object on a display surface of the interactive input system;
program code for displaying multiple graphic objects having a predetermined position within the first graphic object; and
program code for providing user feedback upon placement of the multiple graphic objects, by at least one user, within the first graphic object at the predetermined position.

According to yet another aspect there is provided a computer readable medium embodying a computer program for managing user interactions in a multi-user interactive input system, the computer program code comprising:
program code for displaying at least one graphic object in at least one user area defined on at display surface of the interactive input system; and
program code for limiting the interactions with the at least one graphic object to the at least one user area in response to user interactions with the at least one graphic object.

According to a still further aspect, there is provided a computer readable medium embodying a computer program for managing user input in a multi-user interactive input system, the computer program code comprising:
program code for displaying at least one graphic objects on a touch table of the interactive input system; and
program code for preventing at least one other user from selecting the at least one graphic object for a predetermined time period, in the event that at least one graphic object is selected by one user.

According to another aspect there is provided a multi-touch interactive input system comprising:
a display surface; and
processing structure communicating with the display surface, the processing structure being responsive to receiving a user request to perform an action from one user area defined on the display surface, prompting for input via at least one other user area on the display surface, and in the event that input concurring with the user request is received from the at least one other user area, performing the action.

According to a further aspect, there is provided a multi-touch table comprising:
a display surface; and
processing structure communicating with the display surface, the processing structure displaying a graphical object indicative of a question having a single correct answer on the display surface, displaying multiple possible answers to the question on at least two user areas defined on the display surface, receiving at least one selection of a possible answer from one of the at least two user areas, determining whether the at least one selection is the single correct answer, and providing user feedback in accordance with the determining.

According to yet a further aspect there is provided a multi-touch interactive input system comprising:
a display surface; and
processing structure communicating with the display surface, the processing structure displaying on the display surface a plurality of graphic objects each having a predetermined relationship with at least one respective area defined on the display surface, and providing user feedback upon movement of one or more graphic objects to at least one respective area.

According to another aspect, there is provided a multi-touch interactive input system comprising:
a display surface; and
processing structure communicating with the display surface, the processing structure displaying on the display surface a plurality of graphic objects each having a predetermined relationship with at least one other graphic object, and providing user feedback upon the placement by the more than one user of the graphical objects in proximity to the at least one other graphic object.

According to a still further aspect, there is provided a multi-touch interactive input system comprising:
a display surface; and
processing structure communicating with the display surface, the processing structure being responsive to user interactions with at least one graphic object displayed in at least one user area defined on at display surface, to limit the interactions with the at least one graphic object to the at least one user area.

According to yet another aspect, there is provided a multi-touch interactive input system comprising:
a display surface; and
processing structure communicating with the display surface, the processing structure being responsive to one user selecting at least one graphic object displayed in at least one user area defined on at display surface, to prevent at least one other user from selecting the at least one graphic object for a predetermined time period.

### BRIEF DESCRIPTION OF THE DRAWINGS

Embodiments will now be described more fully with reference to the accompanying drawings in which:

FIG. 1a is a perspective view of an interactive input system.

FIG. 1b is a side sectional view of the interactive input system of FIG. 1a.

FIG. 1c a sectional view of a table top and touch panel forming part of the interactive input system of FIG. 1a.

FIG. 2a illustrates an exemplary screen image displaying on the touch panel.

FIG. 2b is a block diagram illustrating the software structure of the interactive input system.

FIG. 3 is an exemplary view of the touch panel on which two users are working.

FIG. 4 is an exemplary view of the touch panel on which four users are working.

FIG. 5 is a flowchart illustrating the steps performed by the interactive input system for collaborative decision making using a shared object.

FIGS. 6a to 6d are exemplary views of a touch panel on which four users collaborate using control panels.

FIG. 7 shows exemplary views of interference prevention during collaborative activities on a touch table.

FIG. 8 shows exemplary views of another embodiment of interference prevention during collaborative activities on the touch panel.

FIG. 9a is a flowchart illustrating a template for a collaborative interaction activity on the touch table panel.

FIG. 9b is a flow chart illustrating a template for another embodiment of a collaborative interaction activity on the touch table panel.

FIGS. 10a and 10b illustrate an exemplary scenario using the collaborative matching template.

FIGS. 11a and 11b illustrate another exemplary scenario using the collaborative matching template.

FIG. 12 illustrates yet another exemplary scenario using the collaborative matching template.

FIG. 13 illustrates still another exemplary scenario using the collaborative matching template.

FIG. 14 illustrates an exemplary scenario using the collaborative sorting/arranging template.

FIG. 15 illustrates another exemplary scenario using the collaborative sorting/arranging template.

FIGS. 16a and 16b illustrate yet another exemplary scenario using the collaborative sorting/arranging template.

FIG. 17 illustrates an exemplary scenario using the collaborative mapping template.

FIG. 18a illustrates another exemplary scenario using the collaborative mapping template.

FIG. 18b illustrates another exemplary scenario using the collaborative mapping template.

FIG. 19 illustrates an exemplary control panel.

FIG. 20 illustrates an exemplary view of setting up a Tangram application when the administrative user clicks the Tangram application settings icon.

FIG. 21a illustrates an exemplary view of setting up a collaborative activity for the interactive input system.

FIG. 21b illustrates the user of the collaborative activity in FIG. 21a.

### DETAILED DESCRIPTION OF THE EMBODIMENT

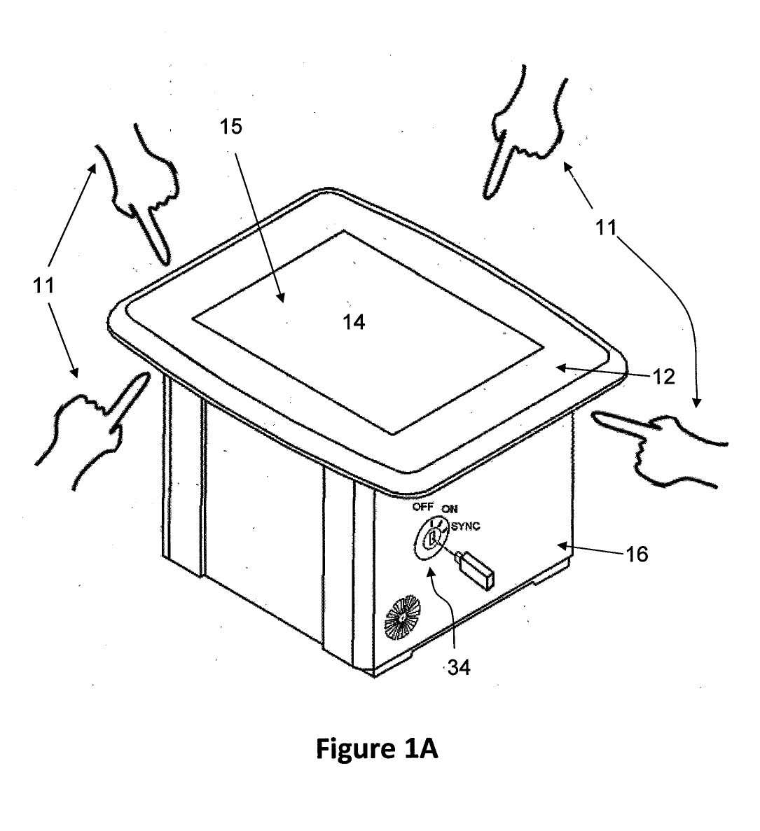

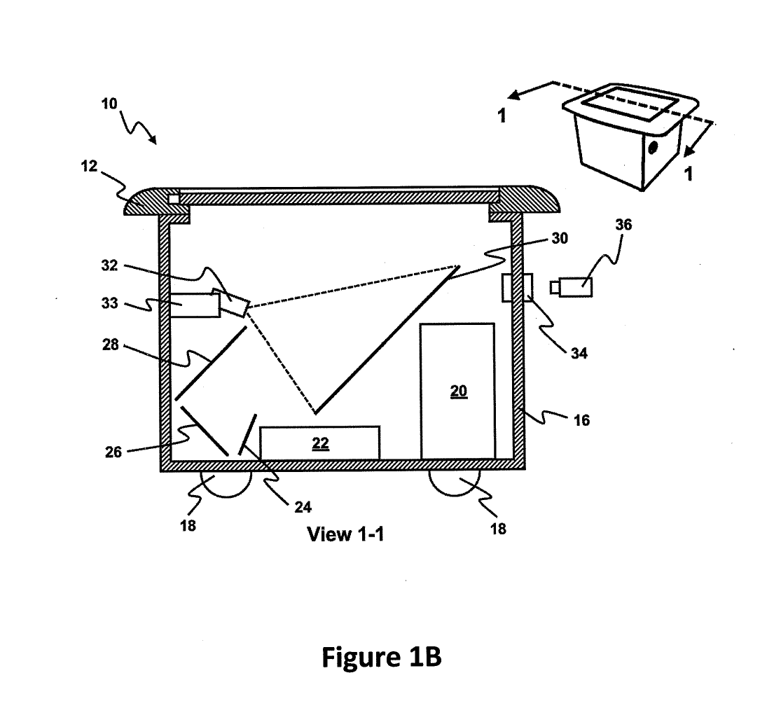

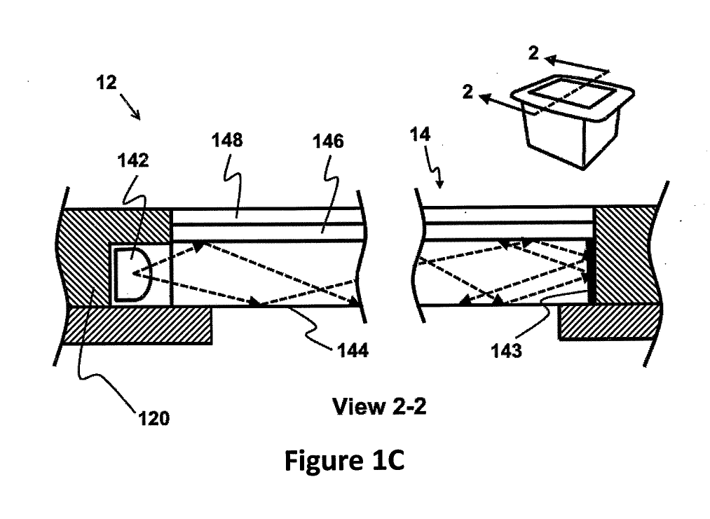

Turning now to FIG. 1a, a perspective diagram of an interactive input system in the form of a touch table is shown and is generally identified by reference numeral 10. Touch table 10 comprises a table top 12 mounted atop a cabinet 16. In this embodiment, cabinet 16 sits atop wheels 18 that enable the touch table 10 to be easily moved from place to place in a classroom environment. Integrated into table top 12 is a coordinate input device in the form of a frustrated total internal refraction (FTIR) based touch panel 14 that enables detection and tracking of one or more pointers 11, such as fingers, pens, hands, cylinders, or other objects, applied thereto.

Cabinet 16 supports the table top 12 and touch panel 14, and houses a processing structure 20 (see FIG. 1b) executing a host application and one or more application programs, with which the touch panel 14 communicates. Image data generated by the processing structure 20 is displayed on the touch panel 14 allowing a user to interact with the displayed image via pointer contacts on the display surface 15 of the touch panel 14. The processing structure 20 interprets pointer contacts as input to the running application program and updates the image data accordingly so that the image displayed on the display surface 15 reflects the pointer activity. In this manner, the touch panel 14 and processing structure 20 form a closed loop allowing pointer interactions with the touch panel 14 to be recorded as handwriting or drawing or used to control execution of the application program.

The processing structure 20 in this embodiment is a general purpose computing device in the form of a computer. The computer comprises for example, a processing unit, system memory (volatile and/or non-volatile memory), other non-removable or removable memory (a hard disk drive, RAM, ROM, EEPROM, CD-ROM, DVD, flash memory, etc.) and a system bus coupling the various computer components to the processing unit.

The processing structure 20 runs a host software application/operating system which, during execution, presents a graphical user interface comprising a canvas page or palette, upon which graphic widgets are displayed. In this embodiment, the graphical user interface is presented on the touch panel 14, such that freeform or handwritten ink objects and other objects can be input and manipulated via pointer interaction with the display surface 15 of the touch panel 14.

FIG. 1b is a side elevation cutaway view of the touch table 10. The cabinet 16 supporting table top 12 and touch panel 14 also houses a horizontally-oriented projector 22, an infrared (IR) filter 24, and mirrors 26, 28 and 30. An imaging device 32 in the form of an infrared-detecting camera is mounted on a bracket 33 adjacent mirror 28. The system of mirrors 26, 28 and 30 functions to “fold” the images projected by projector 22 within cabinet 16 along the light path without unduly sacrificing image size. The overall touch table 10 dimensions can thereby be made compact.

The imaging device 32 is aimed at mirror 30 and thus sees a reflection of the display surface 15 in order to mitigate the appearance of hotspot noise in captured images that typically must be dealt with in systems having imaging devices that are aimed directly at the display surface 15. Imaging device 32 is positioned within the cabinet 16 by the bracket 33 so that it does not interfere with the light path of the projected image.

During operation of the touch table 10, processing structure 20 outputs video data to projector 22 which, in turn, projects images through the IR filter 24 onto the first mirror 26. The projected images, now with IR light having been substantially filtered out, are reflected by the first mirror 26 onto the second mirror 28. Second mirror 28 in turn reflects the images to the third mirror 30. The third mirror 30 reflects the projected video images onto the display (bottom) surface of the touch panel 14. The video images projected on the bottom surface of the touch panel 14 are viewable through the touch panel 14 from above. The system of three mirrors 26, 28, configured as shown provides a compact path along which the projected image can be channeled to the display surface. Projector 22 is oriented horizontally in order to preserve projector bulb life, as commonly-available projectors are typically designed for horizontal placement.

An external data port/switch 34, in this embodiment a Universal Serial Bus (USB) port/switch, extends from the interior of the cabinet 16 through the cabinet wall to the exterior of the touch table 10 providing access for insertion and removal of a USB key 36, as well as switching of functions.

The external data port/switch 34, projector 22, and IR-detecting camera 32 are each connected to and managed by the processing structure 20. A power supply (not shown) supplies electrical power to the electrical components of the touch table 10. The power supply may be an external unit or, for example, a universal power supply within the cabinet 16 for improving portability of the touch table 10. The cabinet 16 fully encloses its contents in order to restrict the levels of ambient visible and infrared light entering the cabinet 16 thereby to facilitate satisfactory signal to noise performance. However, provision is made for the flow of air into and out of the cabinet 16 for managing the heat generated by the various components housed inside the cabinet 16, as shown in U.S. patent application Ser. No. (ATTORNEY DOCKET 6355-260) entitled “TOUCH PANEL FOR AN INTERACTIVE INPUT SYSTEM AND INTERACTIVE INPUT SYSTEM INCORPORATING THE TOUCH PANEL” to Sirotich, et al. filed on even date herewith and assigned to the assignee of the subject application, the content of which is incorporated herein by reference in its entirety.

As set out above, the touch panel 14 of touch table 10 operates based on the principles of frustrated total internal reflection (FTIR), as described in further detail in the above-mentioned U No. (ATTORNEY DOCKET 6355-260) entitled “TOUCH PANEL FOR AN INTERACTIVE INPUT SYSTEM AND INTERACTIVE INPUT SYSTEM INCORPORATING THE TOUCH PANEL” to Sirotich, et al., and in the aforementioned Han reference.

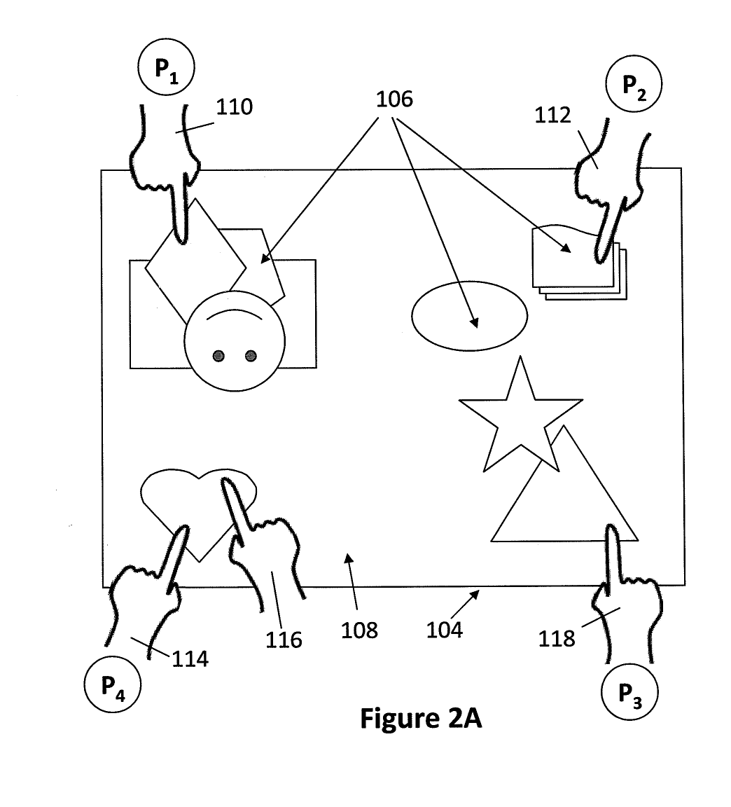

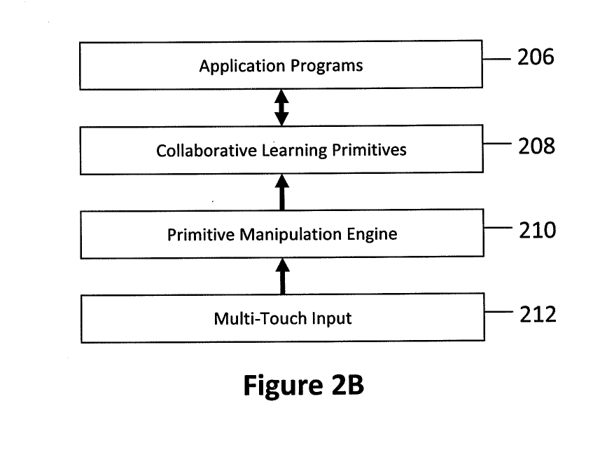

FIG. 1c is a sectional view of the table top 12 and touch panel 14 for the touch table 10 shown in FIG. 2a. Table top 12 comprises a frame 120 supporting the touch panel 14. In this embodiment, frame 120 is composed of plastic. Touch panel 14 comprises an optical waveguide layer 144 that, according to this embodiment, is a sheet of acrylic. A resilient diffusion layer 146 lies against the optical waveguide layer 144. The diffusion layer 146 substantially reflects the IR light escaping the optical waveguide layer 144 down into the cabinet 16, and diffuses visible light being projected onto it in order to display the projected image. Overlying the resilient diffusion layer 146 on the opposite side of the optical waveguide layer 144 is a clear, protective layer 148 having a smooth display surface. While the touch panel 14 may function without the protective layer 148, the protective layer 148 permits use of the touch panel 14 without undue discoloration, snagging or creasing of the underlying diffusion layer 146, and without undue wear on users' fingers. Furthermore, the protective layer 148 provides abrasion, scratch and chemical resistance to the overall touch panel 14, as is useful for panel longevity. The protective layer 148, diffusion layer 146, and optical waveguide layer 144 are clamped together at their edges as a unit and mounted within the table top 12. Over time, prolonged use may wear one or more of the layers. As desired, the edges of the layers may be unclamped in order to inexpensively provide replacements for the worn layers. It will be understood that the layers may be kept together in other ways, such as by use of one or more of adhesives, friction fit, screws, nails, or other fastening methods. A bank of infrared light emitting diodes (LEDs) 142 is positioned along at least one side surface of the optical waveguide layer 144 (into the page in FIG. 1c). Each LED 142 emits infrared light into the optical waveguide layer 144. Bonded to the other side surfaces of the optical waveguide layer 144 is reflective tape 143 to reflect light back into the optical waveguide layer 144 thereby saturating the optical waveguide layer 144 with infrared illumination. The IR light reaching other side surfaces is generally reflected entirely back into the optical waveguide layer 144 by the reflective tape 143 at the other side surfaces.

In general, when a user contacts the display surface 15 with a pointer 11, the pressure of the pointer 11 against the touch panel 14 “frustrates” the TIR at the touch point causing IR light saturating an optical waveguide layer 144 in the touch panel 14 to escape at the touch point. The escaping IR light reflects off of the pointer 11 and scatters locally downward to reach the third mirror 30. This occurs for each pointer 11 as it contacts the display surface at a respective touch point.

As each touch point is moved along the display surface, IR light escapes from an optical waveguide layer 144 at the touch point. Upon removal of the touch point, the escape of IR light from the optical waveguide layer 144 once again ceases. As such, IR light escapes from the optical waveguide layer 144 of the touch panel 14 substantially at touch point location(s).

Imaging device 32 captures two-dimensional, IR video images of the third mirror 30. IR light having been filtered from the images projected by projector 22, in combination with the cabinet 16 substantially keeping out ambient light, ensures that the background of the images captured by imaging device 32 is substantially black. When the display surface 15 of the touch panel 14 is contacted by one or more pointers as described above, the images captured by IR camera 32 comprise one or more bright points corresponding to respective touch points. The processing structure 20 receives the captured images and performs image processing to detect the coordinates and characteristics of the one or more touch points based on the one or more bright points in the captured images, as described in U.S. patent application Ser. No. (ATTORNEY DOCKET NO. 6355-243) entitled “METHOD FOR CALIBRATING AN INTERACTIVE INPUT SYSTEM AND INTERACTIVE INPUT SYSTEM EXECUTING THE METHOD” to Holmgren, et al. and assigned to the assignee of the subject application and incorporated by reference herein in its entirety. The detected coordinates are then mapped to display coordinates, as described in the above-mentioned Holmgren, et al. application, and interpreted as ink or mouse events by the host application running on processing structure 20 for manipulating the displayed image.

The host application tracks each touch point based on the received touch point data, and handles continuity processing between image frames. More particularly, the host application receives touch point data from frames and based on the touch point data determines whether to register a new touch point, modify an existing touch point, or cancel/delete an existing touch point. Thus, the host application registers a Contact Down event representing a new touch point when it receives touch point data that is not related to an existing touch point, and accords the new touch point a unique identifier. Touch point data may be considered unrelated to an existing touch point if it characterizes a touch point that is a threshold distance away from an existing touch point, for example. The host application registers a Contact Move event representing movement of the touch point when it receives touch point data that is related to an existing pointer, for example by being within a threshold distance of, or overlapping an existing touch point, but having a different focal point. The host application registers a Contact Up event representing removal of the touch point from the display surface 15 of the touch panel 14 when touch point data that can be associated with an existing touch point ceases to be received from subsequent images. The Contact Down, Contact Move and Contact Up events are passed to respective elements of the user interface such as graphical objects, widgets, or the background/canvas, based on the element with which the touch point is currently associated, and/or the touch point's current position, as described for example in U.S. patent application Ser. No. (ATTORNEY DOCKET NO. 6355-241) entitled “METHOD FOR SELECTING AND MANIPULATING A GRAPHICAL OBJECT IN AN INTERACTIVE INPUT SYSTEM, AND INTERACTIVE INPUT SYSTEM EXECUTING THE METHOD” to Tse filed on even date herewith and assigned to the assignee of the subject application, the content of which is incorporated herein by reference in its entirety.

As illustrated in FIG. 2, the image presented on the display surface 15 comprises graphic objects including a canvas or background 108 (desktop) and a plurality of graphic widgets 106 such as windows, buttons, pictures, text, lines, curves and shapes. The graphic widgets 106 may be presented at different positions on the display surface 15, and may be virtually piled along the z-axis, which is the direction perpendicular to the display surface 15, where the canvas 108 is always underneath all other graphic objects 106. All graphic widgets 106 are organized into a graphic object hierarchy in accordance with their positions on the z-axis. The graphic widgets 106 may be created or drawn by the user or selected from a repository of graphics and added to the canvas 108.

Both the canvas 108 and graphic widgets 106 may be manipulated by using inputs such as keyboards, mice, or one or more pointers such as pens or fingers. In an exemplary scenario illustrated in FIG. 2, four users P₁, P₂, P₃ and P₄ (drawn representatively) are working on the touch table 10 at the same time. Users P₁, P₂ and P₃ are each using one hand 110, 112, 118 or pointer to operate graphic widgets 106 shown on the display surface 15. User P₄ is using multiple pointers 114, 116 to manipulate a single graphic widget 106.

The users of the touch table 10 may comprise content developers, such as teachers, and learners. Content developers communicate with application programs running on touch table 10 to set up rules and scenarios. A USB key 36 (see FIG. 1b) may be used by content developers to store and upload to touch table 10 updates to the application programs with developed content. The USB key 36 may also be used to identify the content developer. Learners communicate with application programs by touching the display surface 15 as described above. The application programs respond to the learners in accordance with the touch input received and the rules set by the content developer.

FIG. 2b is a block diagram illustrating the software structure of the touch table 10. A primitive manipulation engine 210, part of the host application, monitors the touch panel 14 to capture touch point data 212 and generate contact events. The primitive manipulation engine 210 also analyzes touch point data 212 and recognizes known gestures made by touch points. The generated contact events and recognized gestures are then provided by the host application to the collaborative learning primitives 208 which include graphic objects 106 such as for example the canvas, buttons, images, shapes, video clips, freeform and ink objects. The application programs 206 organize and manipulate the collaborative learning primitives 208 to respond to user's input. At the instruction of the application programs 206, the collaborative learning primitives 208 modify the image displayed on the display surface 15 to respond to users' interaction.

The primitive manipulation engine 210 tracks each touch point based on the touch point data 212, and handles continuity processing between image frames. More particularly, the primitive manipulation engine 210 receives touch point data 212 from frames and based on the touch point data 212 determines whether to register a new touch point, modify an existing touch point, or cancel/delete an existing touch point. Thus, the primitive manipulation engine 210 registers a contact down event representing a new touch point when it receives touch point data 212 that is not related to an existing touch point, and accords the new touch point a unique identifier. Touch point data 212 may be considered unrelated to an existing touch point if it characterizes a touch point that is a threshold distance away from an existing touch point, for example. The primitive manipulation engine 210 registers a contact move event representing movement of the touch point when it receives touch point data 212 that is related to an existing pointer, for example by being within a threshold distance of, or overlapping an existing touch point, but having a different focal point. The primitive manipulation engine 210 registers a contact up event representing removal of the touch point from the surface of the touch panel 104 when reception of touch point data 212 that can be associated with an existing touch point ceases to be received from subsequent images. The contact down, move and up events are passed to respective collaborative learning primitives 208 of the user interface such as graphic objects 106, widgets, or the background or canvas 108, based on which of these the touch point is currently associated with, and/or the touch point's current position.

Application programs 206 organize and manipulate collaborative learning primitives 208 in accordance with user input to achieve different behaviours, such as scaling, rotating, and moving. The application programs 206 may detect the release of a first object over a second object, and invoke functions that exploit relative position information of the objects. Such functions may include those functions handling object matching, mapping, and/or sorting. Content developers may employ such basic functions to develop and implement collaboration scenarios and rules. Moreover, these application programs 206 may be provided by the provider of the touch table 10 or by third party programmers developing applications based on a software development kit (SDK) for the touch table 10.

Methods for collaborative interaction and decision making on a touch table 10 not typically employing a keyboard or a mouse for users' input are provided. The following includes methods for handling unique collaborative interaction and decision making optimized for multiple people concurrently working on a shared touch table system. These collaborative interaction and decision making methods extend the work disclosed in the Morris reference referred to above, provide some of the pedagogical insights of Nussbaum proposed in “Interaction-based design for mobile collaborative-learning software,” by Lagos, et al., in IEEE Software, July-August, 80-89, and “Face to Face collaborative learning in computer science classes,” by Valdivia, R. and Nussbaum, M., in International Journal of Engineering Education, 23, 3, 434-440, the content of which is incorporated herein by reference in its entirety, and are based on many lessons learned through usability studies, site visits to elementary schools, and usability survey feedback.

In this embodiment, workspaces and their attendant functionality can be defined by the content developer to suit specific applications. The content developer can customize the number of users, and therefore workspaces, to be used in a given application. The content developer can also define where a particular collaborative object will appear within a given workspace depending on the given application.

Voting is widely used in multi-user environment for collaborative decision making, where all users respond to a request, and a group decision is made in accordance with voting rules. For example a group decision may be finalized only when all users agree. Alternatively, a “majority rules” system may apply. In this embodiment, the touch table 10 provides highly-customizable supports for two types of voting. The first type involves a user initiating a voting request and other users responding to the request by indicating whether they concur or not with the request. For example, a request to close a window may be initiated by a first user, requiring concurrence by one or more other users.

The second type involves a lead user, such as a meeting moderator or a teacher, initiating a voting request by providing one or more questions and a set of possible answers, and other users responding to the request by selecting respective answers. The user initiating the voting request then decides if the answers are correct, or which answer or answers best match the questions. The correct answers of the questions may be pre-stored in the touch table 10 and used to configure the collaboration interaction templates provided by the application programs 206.

Interactive input systems requiring that each user operate their own individual control panel, each performing the same or similar function, tend to suffer from a waste of valuable display screen real estate. However, providing a single control for multiple users tends to lead to disruption when, for example, one user performs an action without the consent of the other users. In this embodiment, a common graphic object, for example, a button, is shared among all touch table users, and facilitates collaborative decision making. This has the advantage of significantly reducing amount of display screen space required for decision making, while reducing unwanted disruptions. To make a group decision, each user is prompted to manipulate the common graphic object one-by-one to make a personal decision input. When a user completes the manipulation on the common graphic object, or after a period of time, T, for example, two (2) seconds, the graphic object is moved to or appears in an area on the display surface proximate the next user. When the graphic object has cycled through all users and all users have made their personal decision inputs, the touch table 10 responds by applying the voting rules to the personal decision inputs. Optionally, the touch table 10 could cycle back to all the users that did not make personal decisions to allow them multiple chances to provide their input. The cycling could be infinite or with a specific time of cycles upon which the cycling terminates and the decision based on the majority input is used.

Alternatively, if the graphic object is at a location remote to the user, the user may perform a special gesture (such as a double tap) in the area proximate to the user where the graphic object would normally appear. The graphic object would then move to or appear at a location proximate the user.

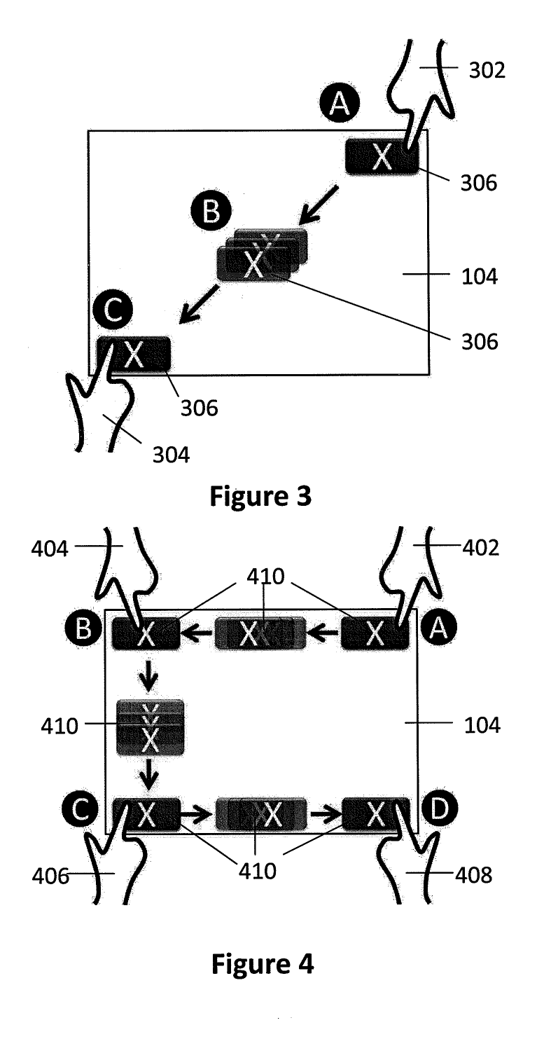

FIG. 3 is an exemplary view of a touch panel 104 on which two users are working. Shown in this figure, the first user 302 presses the close application button 306 proximate to a user area defined on the display surface 15 to make the personal request to close the display of a graphic object (not shown) associated with the close application button 306, and thereby initiate a request for a collaborative decision (A). Then, the second user 304 is prompted to close the application when the close application button 306 appears in another user area proximal the second user 304 (B). At C, if the second user 304 presses the close application button 306 within T seconds, the group decision is then made to close the graphic object associated with the close application button 306. Otherwise, the request is cancelled after T seconds.

FIG. 4 is an exemplary view of a touch panel 104 on which four users are working. Shown in this figure, a first user 402 presses the close application button 410 to make a personal decision to close the display of a graphic object (not shown) associated with the close application button 410, and thereby initiate a request of collaborative decision making (A). Then, the close application button 410 moves to the other users 404, 406 and 408 in sequence, and stays at each of these users for T seconds (B, C and D). Alternatively, the close application may appear at a location proximate the next user upon receiving input from the first user. If any of the other users 404, 406 and 408 wants to agree with the user 402, the other users must press the close application button within T seconds when the button is at their corner. The group decision is made in accordance with the decision of the majority of the users.

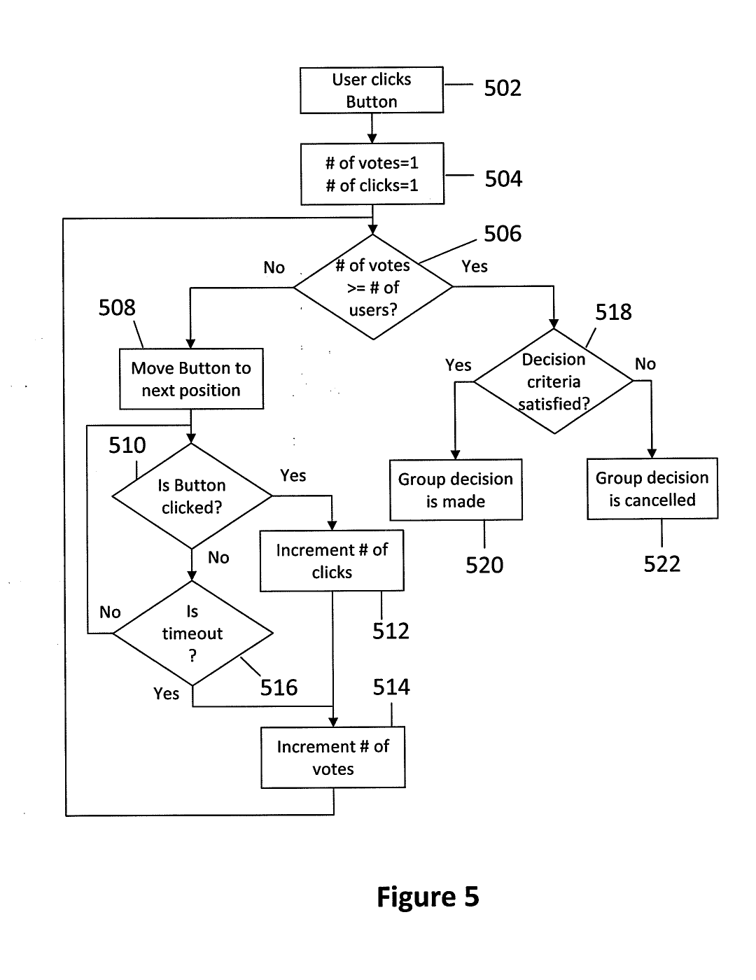

FIG. 5 is the flowchart illustrating the steps performed by the touch table 10 during collaborative decision making for a shared graphic object. At step 502, a first user presses the shared graphic object. At step 504, the number of users that have voted (i.e., # of votes) and the number of users that agree with the request (i.e., # of clicks) are set to one (1) respectively. A test is executed to check if the number of votes is greater than or equal to the number of users (step 506). If the number of votes is less than the number of users, the shared graphic object is moved to the next position (step 508), and a test is executed to check if the graphic object is clicked (step 510). If the graphic object is clicked, the number of clicks is increased by 1 (step 512), and the number of votes is also increased by 1 (step 514). The procedure then goes back to step 506 to test if all users have voted. At step 510, if the graphic object is not clicked, a test is executed to check if T seconds have elapsed (step 516). If not, the procedure goes back to step 510 to wait for the user to click the shared graphic object; otherwise, the number of votes is increased by 1 (step 514) and the procedure goes back to step 506 to test if all users have voted. If all users have voted, a test is executed to check if the decision criteria is met (step 518). The decision criteria may be that the majority of users must agree, or that all users must agree. The group decision is made if the decision criteria are satisfied (step 520); otherwise the group decision is cancelled (step 522).

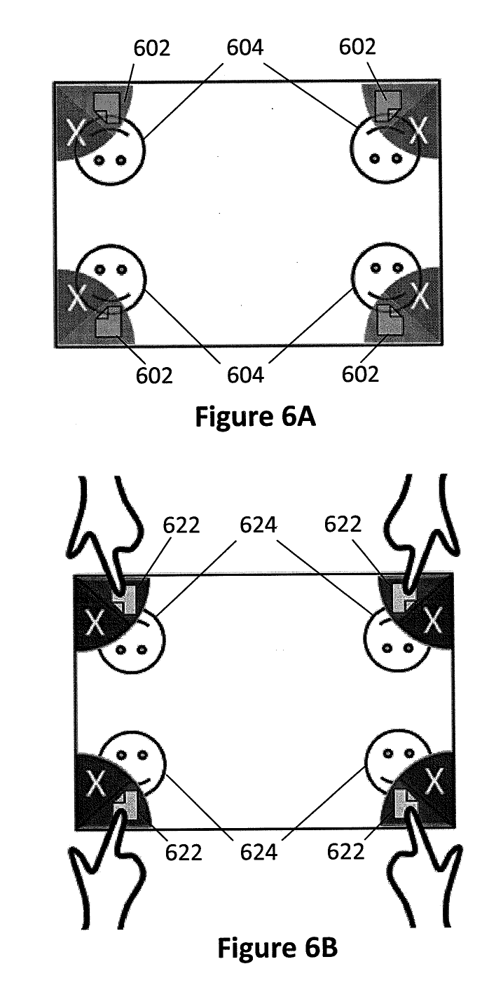

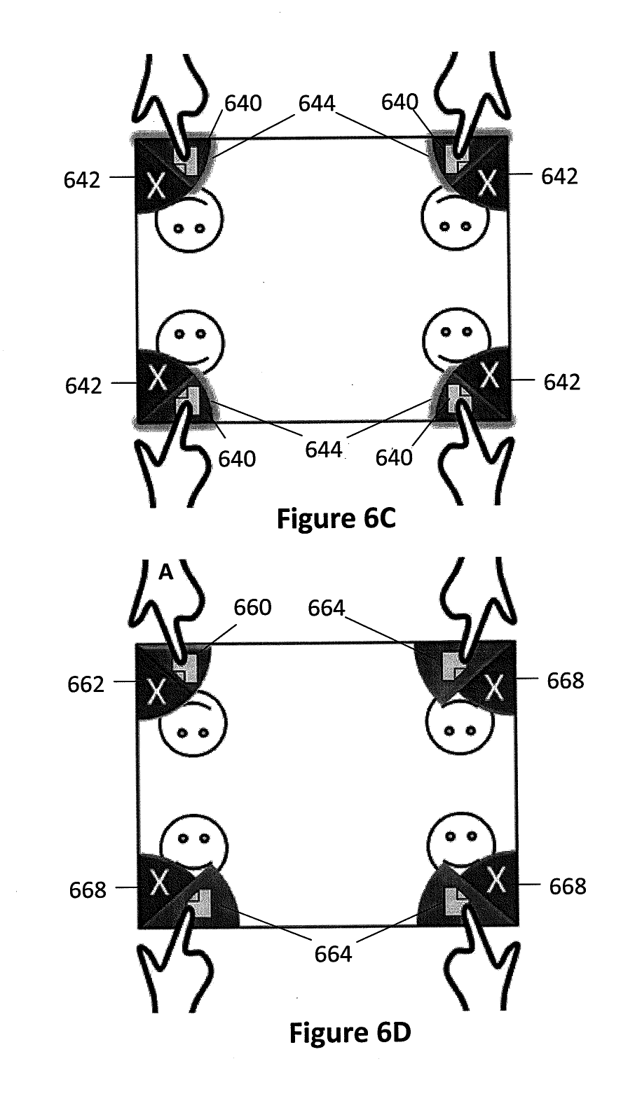

In another embodiment, a control panel is associated with each user. Different visual techniques may be used to reduce the display screen space occupied by the control panels. As illustrated in FIG. 6a, in a preferred embodiment, when no group decision is requested, control panels 602 are in an idle status, and are displayed on the touch panel in a semi-transparent style, so that users can see the content and graphic objects 604 or background below the control panels 602.

When a user touches a tool in a control panel 602, one or all control panels are activated and their style and/or size may be changed to prompt users to make their personal decisions. Shown in FIG. 6b, when a user touches his control panel 622, all control panels 622 become opaque. In FIG. 6c, when a first user touches a “New File” tool 640 in a first control panel 642, all control panels 642 become opaque, and the “New File” tool 640 in every control panel is highlighted, for example a glow effect 644 surrounds the tool. In another example, the tool may become enlarged. In FIG. 6d, when user A touches a “New File” tool 660 in the first user's control panel 662, all control panels 662 and 668 become opaque, and the “New File” tool 664 in other users' control panels 668 are enlarged to prompt other users to make their personal decision. When each user clicks the “New File” tool in their respective control panels 662, 668 to agree with the request, the “New File” tool is reset to its original size.

Those skilled in the art will appreciate that other visual effects, as well as audio effects, may also be applied to activated control panels, and the tools that are used for group decision making. Those skilled in the art will also appreciate that different visual/audio effects may be applied to activated control panels, and the tools that are used for group decision making, to differentiate the user who initiates the request, the users who have made their personal decisions, and the users who have not yet made their decisions.

In this embodiment, the visual/audio effects applied to activated control panels, and the tools that are used for group decision making, last for S seconds. All users must make their personal decisions within the S-second period. If a user does not make any decision within the period, it means that this user does not agree with the request. A group decision is made after the S-second period elapses.

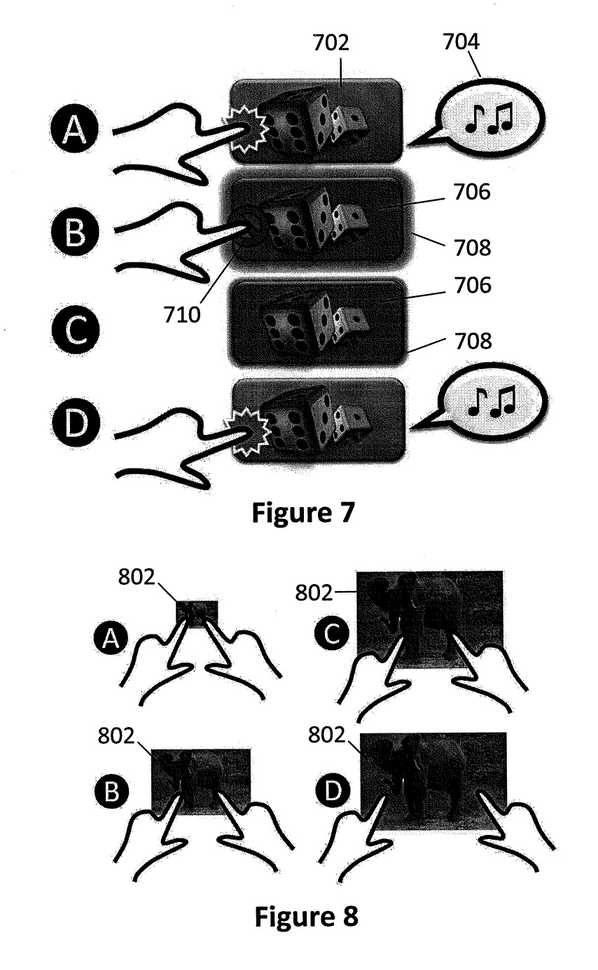

In touch table applications as described in FIGS. 4 and 6, interference by one user during group activities or into another user's space is a concern. Continuously manipulating a graphic object may interfere with group activities. The collaborative learning primitives 208 employ a set of rules to prevent global actions from interfering with group collaboration. For example, if a button is associated with a feedback sound, then, pressing this button continually would disrupt the group activity and generate a significant amount of sound on the table. FIG. 7 shows an example of a timeout mechanism to prevent such interferences. In (A), a user presses the button 702 and a feedback sound 704 is made. Then, a timeout period is set for this button, and the button 702 is disabled within the timeout period. Shown in (B), several visual cues are also set on the button 702 to indicate that the button 702 cannot be clicked. These visual cues may comprise, but are not limited to, modifying the background color 706 of the button to indicate that the button 702 is inactive, adding a halo 708 around the button, and changing the cursor 710 to indicate that the button cannot be clicked. Alternatively, the button 702 may have the visual indicator of an overlay of a cross-through. During the timeout period, clicking the button 702 does not trigger any action. The visual cues may fade with time. For example, in (C) the halo 708 around the button 702 becomes smaller and fades away, indicating that the button 702 is almost ready to be clicked again. Shown in (D), a user clicks the button 702 again after the timeout period elapses, and the feedback sound is played. The described interference prevention may be applied in any application that utilizes a shared button where continuous clicking of a button will interfere with the group activity.

Scaling a graphic object to a very large size may interfere with group activities because the large graphic object may cover other graphic objects with which other users are interacting. On the other hand, scaling a graphic object to a very small size may also interfere with group activities because the graphic object may become difficult to find or reach for some users. Moreover, because using two fingers to scale a graphic object is widely used in touch panel systems, if an object is scaled to a very small size, it may be very difficult to be scaled up again because one cannot place two fingers over it due to its small size.

Minimum and maximum size limits may be applied to prevent such interference. FIG. 8 shows exemplary views of a graphic object scaled between a maximum size limit and a minimum size limit. In (A), a user shrinks a graphic object 802 by moving the two fingers or touch points 804 on the graphic object 802 closer. In (B), once the graphic object 802 has been shrunk to its minimum size such that the user is still able to select and manipulate the graphic object 802, moving the two touch points 804 closer in a gesture to shrink the graphic object does not make the graphic object smaller. In FIG. 8c, the user moves the two touch points 804 apart to enlarge the graphic object 802. Shown in (C), the graphic object 802 has been enlarged to its maximum size such that the graphic object 802 maximizes the user's predefined space on the touch panel 806 but does not interfere with other users' spaces on the touch panel 806. Moving the two touch points 804 further apart does not further enlarge the graphic object 802. Optionally, zooming a graphic object may be allowed to a specific maximum limit (e.g., 4× optical zoom) where the user is able to enlarge the graphic object 802 to a maximum zoom to allow the details of the graphic object 802 to be better viewed.

The application programs 206 utilize a plurality of collaborative interaction templates for programmers and content developers to easily build application programs utilizing collaborative interaction and decision making rules and scenarios for a second type voting. Users or learners may also use the collaborative interaction templates to build collaborative interaction and decision making rules and scenarios if they are granted appropriate rights.

A collaborative matching template provides users a question, and a plurality of possible answers. A decision is made when all users select and move their answers over the question. Programmers and content developers may customize the question, answers and the appearance of the template to build interaction scenarios.

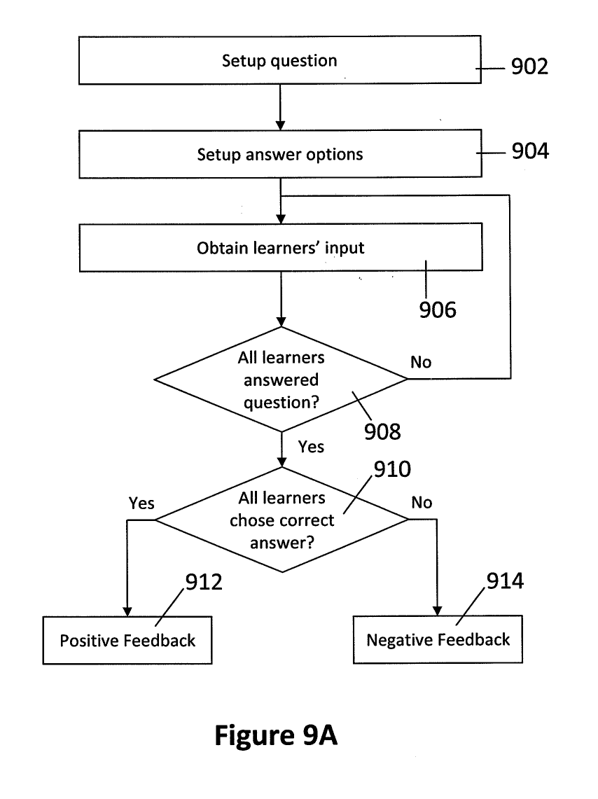

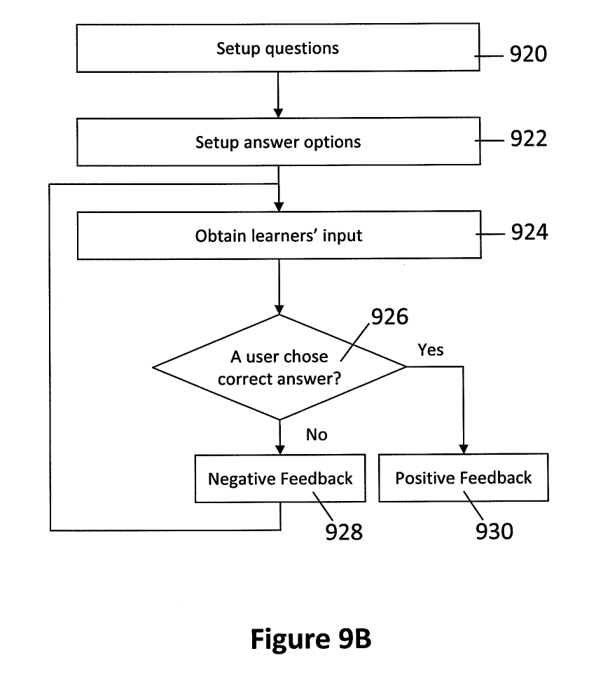

FIG. 9a shows a flowchart that describes a collaborative interaction template. A question set up by the content developer is displayed in step 902. Answers options set up by the content developer that set out the rules to answer the question are displayed in step 904. In step 906, the application then obtains the learners' input to answer the question via the rules set up in step 904 for answering the question. In step 908, if all the learners have not entered their input, the program application returns to step 906 to obtain the input from all the users. Once all the learners have made their input, in step 910, the application program analyzes the input to determine if the input is correct or incorrect. This analysis may be done by matching the learners' input to the answer options set up in step 904. If the input is correct, then in step 912, a positive feedback is provided to the learners. If the input is incorrect, then in step 914, a negative feedback is provided to the learners. Positive and negative feedback to the learners may take the form of a visual, audio, or tactile indicator or a combination of any of those three indicators. Positive feedback to the learners may take the form of a visual, audio, or tactile indicator or a combination of any of those three indicators.

FIG. 9b shows a flowchart that describes another embodiment of a collaborative interaction template. In step 920, a question set up by the content developer is displayed. In step 922, answer options set up by the content developer that set out the rules to answer the question are displayed. In step 924, the application then obtains the learners' input to answer the question via the rules set up in step 922 for answering the question. The program application then determines if any of the learners' or users' input correctly answers the question in step 926. This analysis may be done by matching the learners' input to the answer options set up in step 922. If none of the learners' input correctly answers the question, the program application returns to step 924 and obtains the learners' input again. If any of the input is correct, a positive feedback is provided to the learners in step 930.

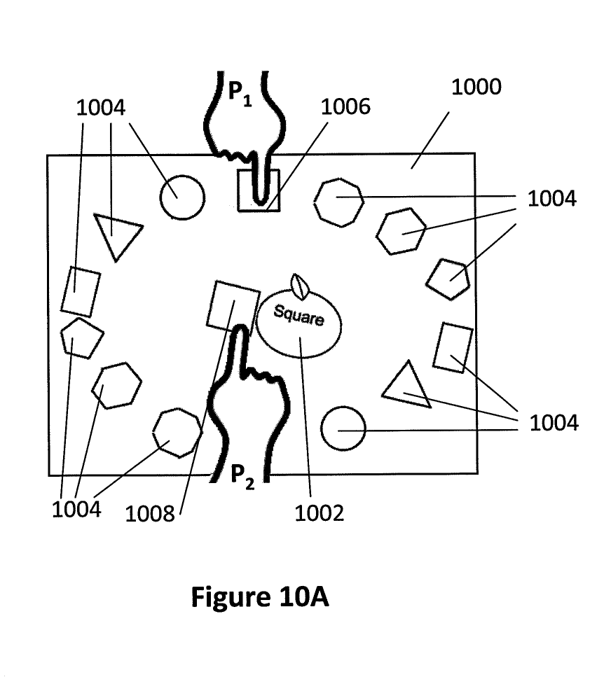

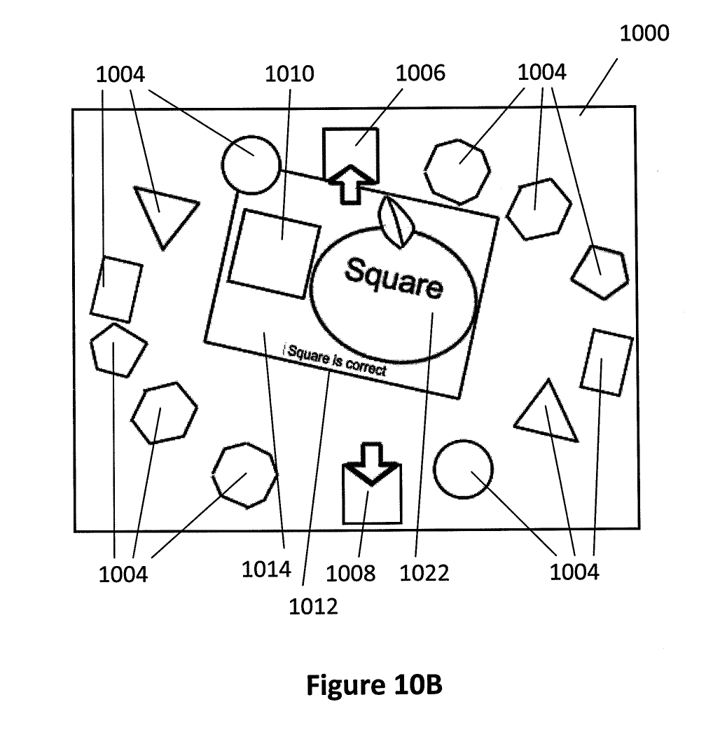

FIGS. 10a and 10b illustrate an exemplary scenario using the collaborative matching template illustrated in FIG. 9a. In this example, a question is posed where users must select graphic objects to answer the question. As illustrated in FIG. 10a where a first user P₁ and a second user P₂ are working on the touch table, the question 1002 asking for a square is shown in the center of the display surface 1000, and a plurality of possible answers 1004, 1006 and 1008 with different shapes are distributed around the question 1002. First users P₁ and second user P₂ select a first answer shape 1006 and second answer shape 1008, respectively, and move the answers 1006 and 1008 over the question 1002. Because the answers 1006 and 1008 match the question 1002, in FIG. 10b, the touch table system gives a sensory indication that the answers are correct. Some examples of this sensory indication may include playing an audio feedback (not shown), such as applause or a musical tone, or displaying a visual feedback such as an enlarged question image 1022, an image 1010 representing the answers that users selected, a text “Square is correct” 1012, and a background image 1014. After the sensory indication is given, the first answer 1006 and second answer 1008 that first users P₁ and second user P₂ respectively moved over the question 1002 in FIG. 10a are moved back to their original positions in FIG. 10b.

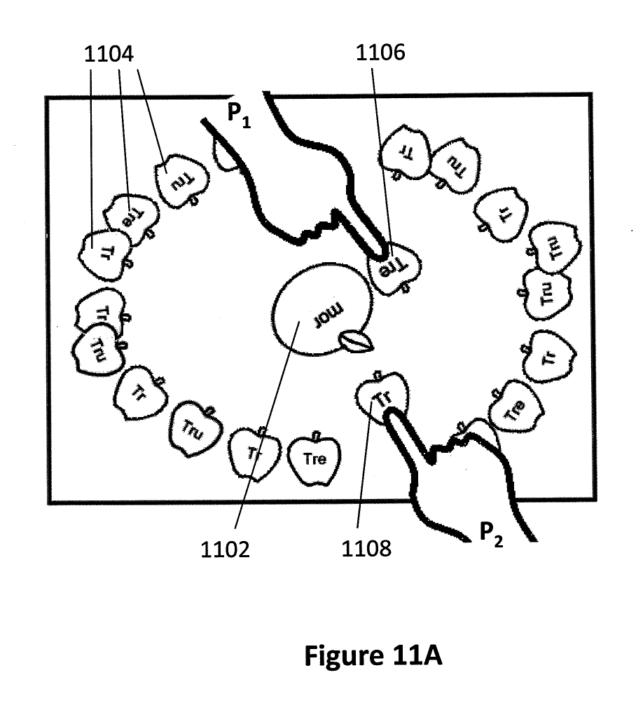

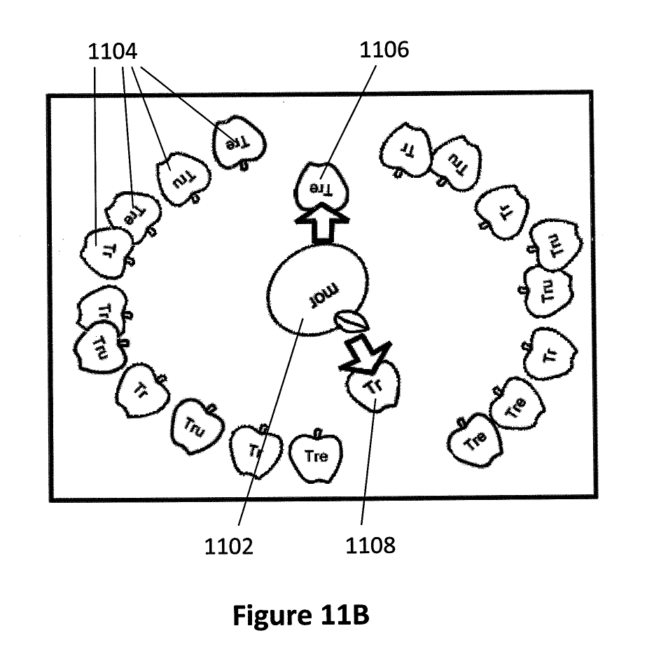

FIGS. 11a and 11b illustrate another exemplary scenario using the collaborative matching template illustrated in FIG. 9a. In this example, the user answers do not match the question. As illustrated in FIG. 11a where a first user P₁ and a second user P₂ are working on the touch table, a question 1102 asking for three letters is shown in the center of the touch panel, and a plurality of possible answers 1104, 1106 and 1108 having different number of letters are distributed around the question 1102. First user P₁ selects a first answer 1106, which contains three letters, and moves it over the question 1102, thereby correctly answering the question 1102. However, user P₂ selects a second answer 1108, which contains two letters, and moves it over the question 1102, thereby incorrectly answering the question 1102. Because the first answer 1106 and the second answer 1108 are not the same and the second answer 1108 from second user P₂ does not answer the question 1102 or match the first answer 1106, in FIG. 11b, the touch table 10 rejects the answers by placing the first answer 1106 and second answer 1108 between their original positions and the question 1102, respectively.

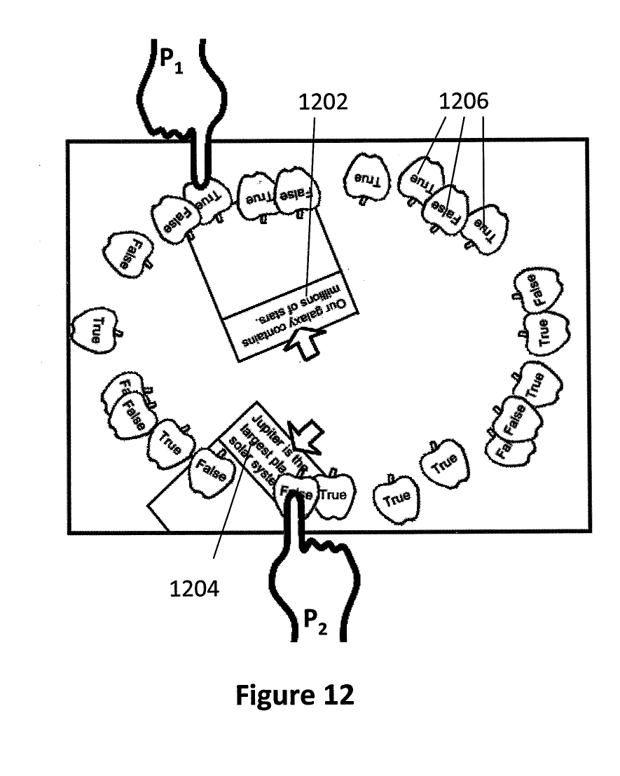

FIG. 12 illustrates yet another exemplary scenario using the template illustrated in FIG. 9b for collaborative matching of graphic objects. In this figure, a first user P₁ and a second user P₂ are operating the touch table 10. In this example, multiple questions exist on the touch panel at the same time. In this figure, a first question 1202 and a second question 1204 appear on the touch panel and are oriented towards the first user and second user respectively. Unlike the templates described in FIG. 10a to FIG. 11b where the question would not respond to users' action until all users have selected their graphic object answers 1206, this template employs a “first answer wins” policy, whereby the application accepts a correct answer as soon as a correct answer is given.

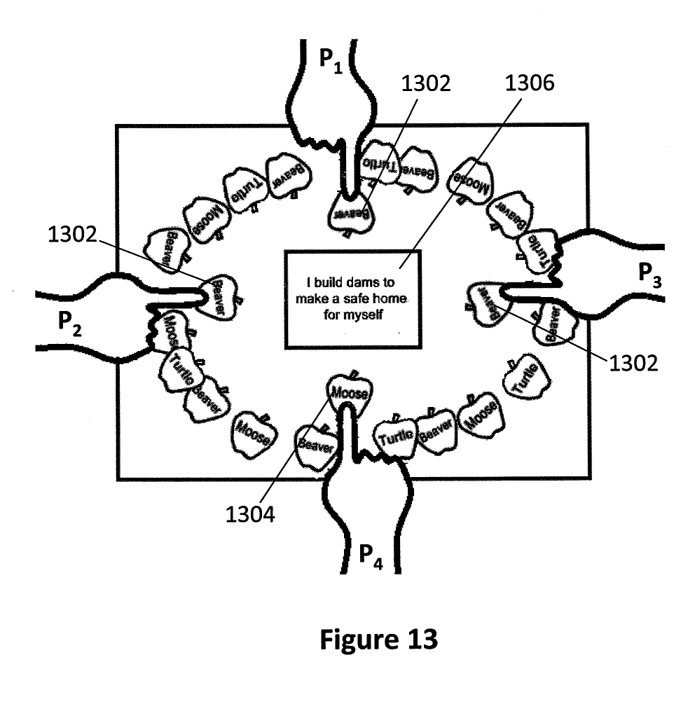

FIG. 13 illustrates still another exemplary scenario using the template for collaborative matching of graphic objects. In this figure, a first user P₁, a second user P₂, a third user P₃, and a fourth user P₄ are operating the touch table system. In this example a majority rules policy is implemented where the most common answer is selected. Shown in this figure, first user P₁, second user P₂, and third user P₃ select a same graphic object answer 1302 while the fourth user P₄ selects another graphic object answer 1304. Thus, the group answer for a question 1306 is the answer 1302.

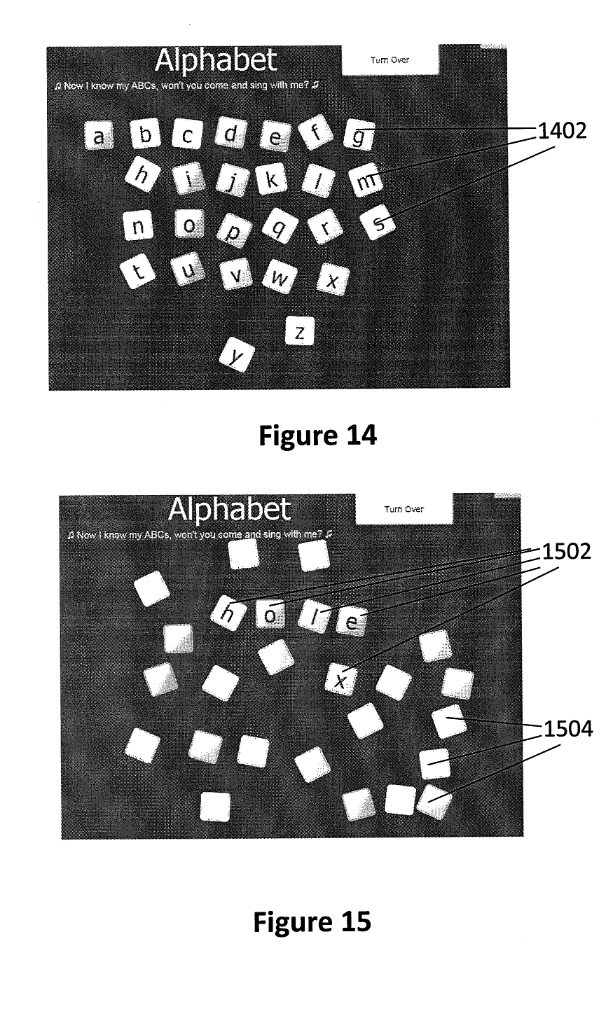

FIG. 14 illustrates an exemplary scenario using a collaborative sorting and arranging of graphic objects template. In this figure, a plurality of letters 1402 are provided on the touch panel, and users are asked to place the letters in alphabetic order. The ordered letters may be placed in multiple horizontal lines as illustrated in FIG. 14. Alternatively, they may be placed in multiple vertical lines, one on top of another, or in other forms.

FIG. 15 illustrates another exemplary scenario using the collaborative sorting/arranging template. In this figure, a plurality of letters 1502 and 1504 are provided on the touch panel. The letters 1504 are turned over by the content developer or teacher so that the letters are hidden and only the background of each letter 1504 can be seen. Users or learners are asked to place the letters 1502 in an order to form a word.

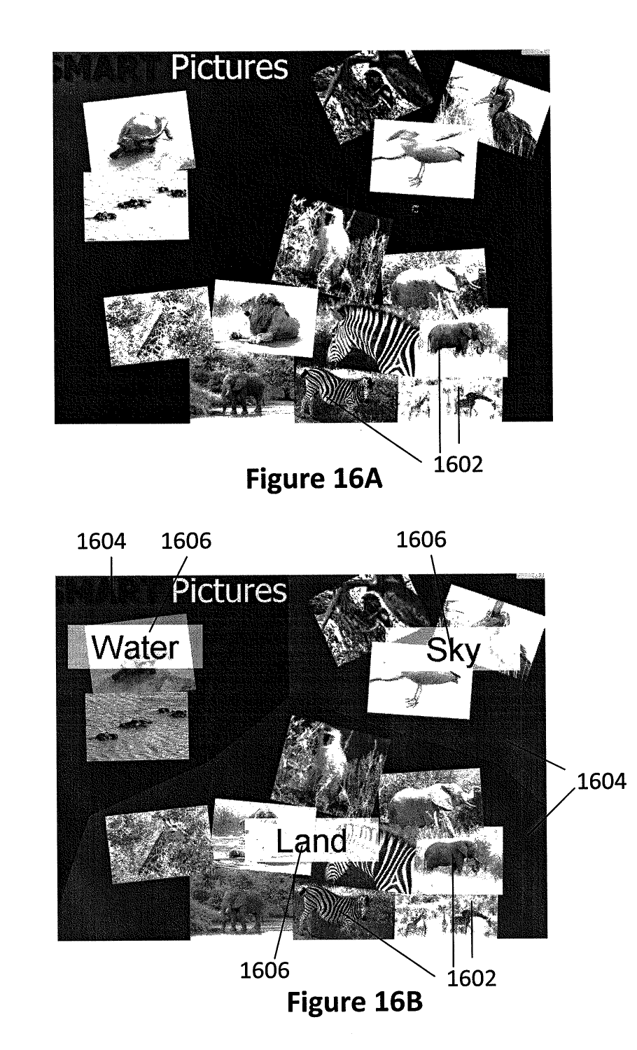

FIGS. 16a and 16b illustrate yet another exemplary scenario using a template for the collaborative sorting and arranging of graphic objects. A plurality of pictures 1602 are provided on the touch panel. Users are asked to arrange pictures 1602 into different groups on the touch panel in accordance with the requirement of the programmer or content developer or the person who designs the scenario. In FIG. 16b, the screen is divided into a plurality of areas 1604, each with a category name 1606, provided for arranging tasks. Users are asked to place each picture 1602 into an appropriate area that describes one of the characteristics of the content of the picture. In this example, a picture of birds should be placed in the area of “sky”, and a picture of an elephant should be placed in the area of “land”, etc.

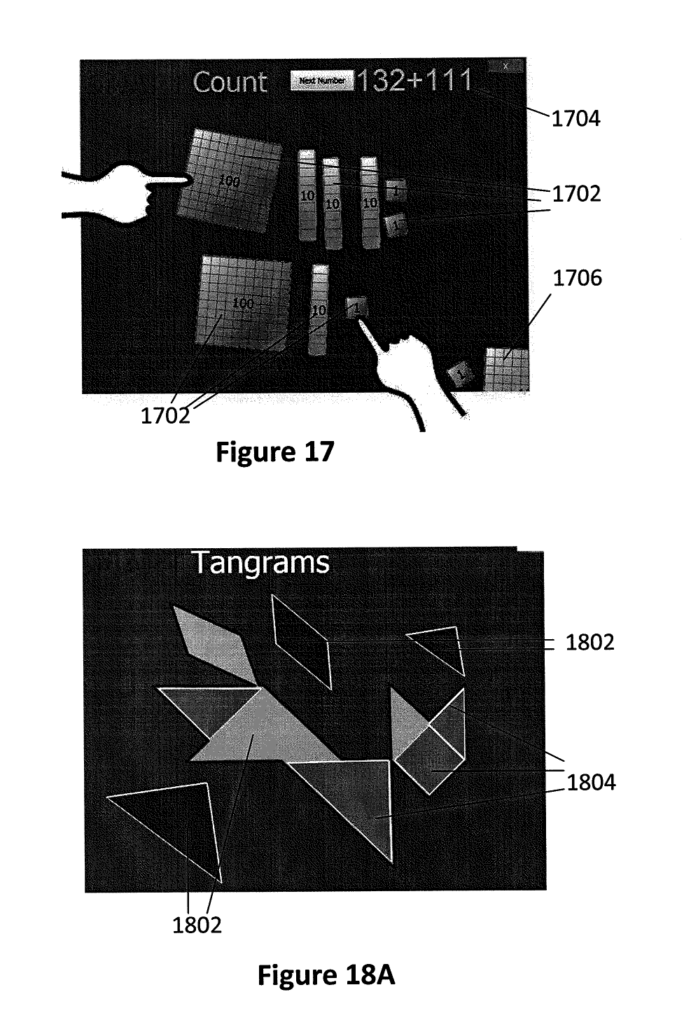

FIG. 17 illustrates an exemplary scenario using the template for collaborative mapping of graphic objects. The touch table 10 registers a plurality of graphic items such as, shapes 1702 and 1706 that contain different number of blocks. Initially, the shapes 1702 and 1706 are placed at a corner of the touch panel, and a math equation 1704 is displayed on the touch panel. Users are asked to drag appropriate shapes 1702 from the corner to the center of the touch panel to form the math equation 1704. The touch table 10 recognizes the shapes placed in the center of the touch panel, and dynamically shows the calculation result on the touch panel. Alternatively, the user simply clicks the appropriate graphic objects in order to produce the correct output. Unlike aforementioned templates, when a shape is dragged out from the corner that stores all shapes, a copy of the shape is left in the corner. In this way, the learner can use a plurality of the same shapes to answer the question.

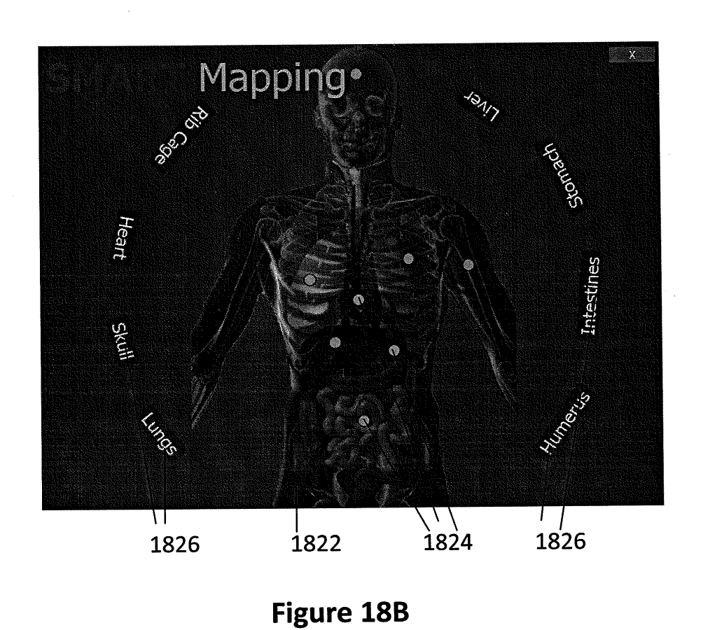

FIG. 18a illustrates another exemplary scenario using the template for collaborative mapping of graphic objects. A plurality of shapes 1802 and 1804 are provided on the touch panel, and users are asked to place the shapes 1802 and 1804 into appropriate position. When a shape 1804 is placed in the correct position, the touch system indicates a correct answer by a sensory indication including but not limited to highlighting the shape 1804 by changing the shape color, adding a halo or an outline with a different color to the shape, enlarging the shape briefly, and/or providing an audio effect. Any of these indications may happen individually, simultaneously or concurrently.

FIG. 18b illustrates yet another exemplary scenario using the template for collaborative mapping of graphic objects. An image of the human body 1822 is displayed at the center of the touch panel. A plurality of dots 1824 are shown on the image of the human body indicating the target positions that the learners must place their answers on. A plurality of text objects 1826 showing the organ names are placed around the image of the human body 1822. Alternatively, the objects 1822 and 1826 may also be other types such as for example, shapes, pictures, movies, etc. In this scenario, objects 1826 are automatically oriented to face the outside of the touch table.

In this scenario, learners are asked to place each of the objects 1826 onto an appropriate position 1824. When an object 1826 is placed on an appropriate position 1824, the touch table system provides a positive feedback. Thus, the orientation of the object 1826 is irrelevant in deciding if the answer is correct or not. If an object 1826 is placed on a wrong position 1824, the touch table system provides a negative feedback.

The collaborative templates described above are only exemplary. Those of skill in the art will appreciate that more collaborative templates may be incorporated into touch table systems by utilizing the ability of touch table systems for recognizing the characteristics of graphic objects, such as, shape, color, style, size, orientation, position, and the overlap and the z-axis order of multiple graphic objects.

The collaborative templates are highly customizable. These templates are created and edited by a programmer or content developer on a personal computer or any other suitable computing device, and then loaded into the touch table system by a user who has appropriate access rights. Alternatively, the collaborative templates can also be modified directly on the tabletop by users with appropriate access rights.

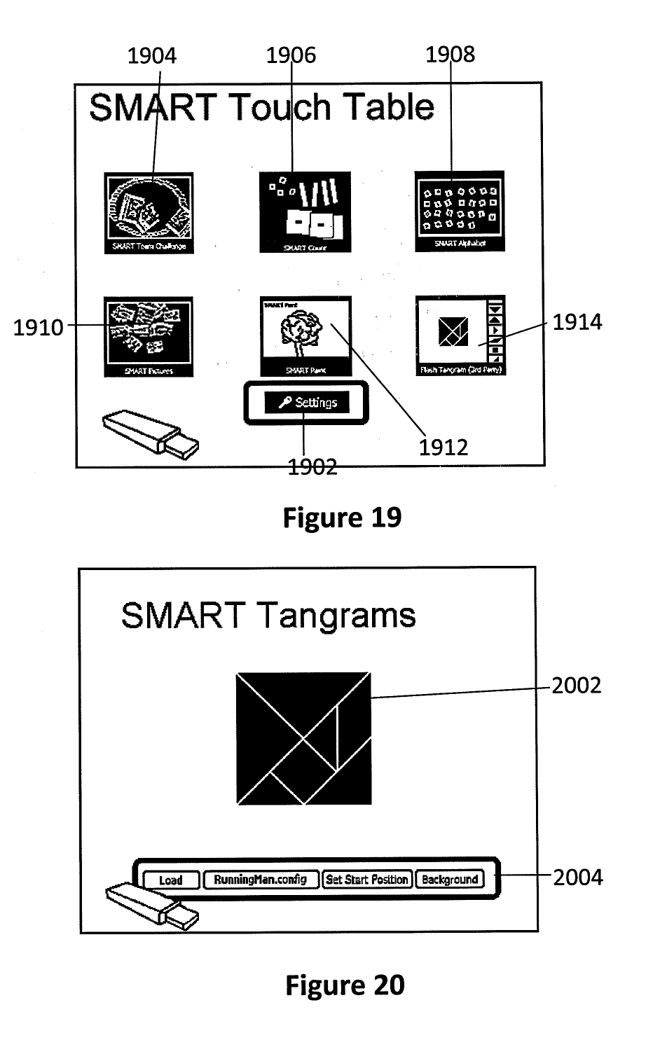

The touch table 10 provides administrative users such as content developers with a control panel. Alternatively, each application installed in the touch table may also provide a control panel to administrative users. All control panels can be accessed only when an administrative USB key is inserted into the touch table. In this example, a SMART™ USB key with a proper user identity is plugged to the touch table to access the control panels as shown in FIG. 1b. FIG. 19 illustrates an exemplary control panel which comprises a Settings button 1902 and a plurality of application setting icons 1904 to 1914. The Settings button 1902 is used for adjusting general touch table setting, such as the number of users, graphical settings, video and audio setting, etc. The application setting icons 1904 to 1914 are used for adjusting application configurations and for designing interaction templates.

FIG. 20 illustrates an exemplary view of setting up the Tangram application shown in FIG. 18. When the administrative user clicks the Tangram application settings icon 1914 (see FIG. 19), a rectangular shape 2002 is displayed on the screen and is divided into a plurality of parts by the line segments. A plurality of buttons 2004 are displayed at the bottom of the touch panel. The administrative user can manipulate the rectangular shape 2002 and/or use the buttons 2004 to customize the Tangram game. Such configurations may include setting the start position of the graphic objects, or changing the background image or color, etc.

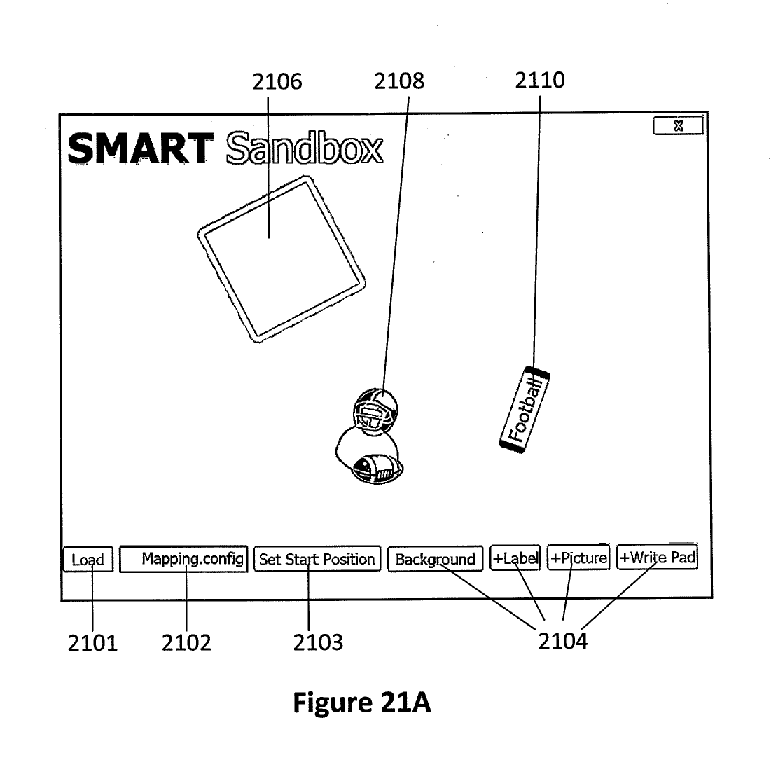

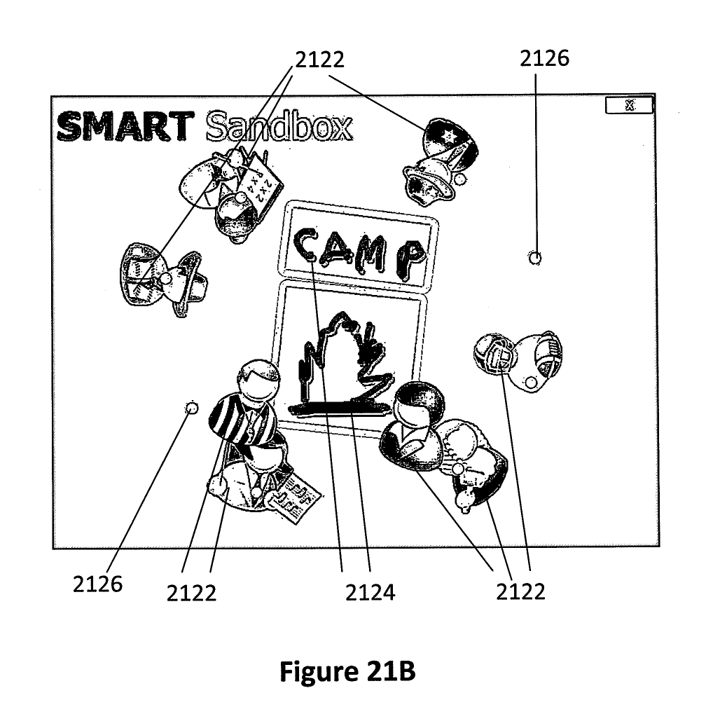

FIGS. 21a and 21b illustrate another exemplary Sandbox application employing the crossing methods described in FIGS. 5a and 5b to create complex scenarios that combine aforementioned templates and rules. By using this application, content developers may create their own rules, or create free-form scenarios that have no rules.

FIG. 21a shows a screen shot of setting up a scenario using a “Sandbox” application. A plurality of configuration buttons 2101 to 2104 is provided to content developers at one side of the screen. Content developers may use the buttons 2104 to choose a screen background for their scenario, or add a label/picture/write pad object to the scenario. In the example shown in FIG. 21a, the content developer has added a write pad 2106, a football player picture 2108, and a label with text “Football” 2110 to her scenario. The content developer may use the button 2103 to set up start position for the objects in her scenario, and then set up target positions for the objects and apply the aforementioned mapping rules. If no start position or target position is defined, no collaborative rule is applied and the scenario is a free-form scenario. The content developer may also load scenarios from the USB key by pressing the Load button 2101, or save the current scenario by clicking the button 2102, which pops up a dialog box, and writing a configuration file name in the pop-up dialog box.

FIG. 21b is a screen shot of the scenario created in FIG. 21a in action. The objects 2122 and 2124 are distributed at the start positions the content developer designates, and the target positions 2126 are marked as dots. When learners utilize the scenario, a voice instruction recorded by the content developer may be automatically played to tell learners how to play this scenario and what are the tasks they must perform.

The embodiments described above are only exemplary. Those skilled in the art will appreciate that the same techniques can also be applied to other collaborative interaction applications and systems, such as, direct touch systems that use graphical manipulation for multiple people, such as, touch tabletop, touch wall, kiosk, tablet, etc, and systems employing distant pointing techniques, such as, laser pointers, IR remote, etc.

Also, although the embodiments described above are based on multiple-touch panel systems, those of skill in the art will appreciate that the same techniques can also be applied in single-touch systems, and allow users to smoothly select and manipulate graphic objects by using a single finger or pen in a one-by-one manner.

Although the embodiments described above are based on manipulating graphic objects, those of skill in the art will appreciate that the same technique can also be applied to manipulate audio/video clips and other digital media.

Those of skill in the art will also appreciate that the same methods of manipulating graphic objects described herein may also apply to different types of touch technologies such as surface-acoustic-wave (SAW), analog-resistive, electromagnetic, capacitive, IR-curtain, acoustic time-of-flight, or optically-based looking across the display surface.

The multi-touch interactive input system may comprise program modules including but not limited to routines, programs, object components, data structures, etc. and may be embodied as computer readable program code stored on a computer readable medium. The computer readable medium is any data storage device that can store data, which can thereafter be read by a computer system. Examples of computer readable medium include for example read-only memory, random-access memory, flash memory, CD-ROMs, magnetic tape, optical data storage devices and other storage media. The computer readable program code can also be distributed over a network including coupled computer systems so that the computer readable program code is stored and executed in a distributed fashion or copied over a network for local execution.

Those of skill in the art will understand that collaborative decision making is not limited solely to a display surface and may be extended to online conferencing systems where users at different locations could collaboratively decide, for example, when to end the session. The icons for activating the collaborative action would display in a similar timed manner at each remote location as described herein. Similarly, a display surface employing an LCD or similar display and an optical digitizer touch system could be employed.

Although the embodiment described above uses three mirrors, those of skill in the art will appreciate that different mirror configurations are possible using fewer or greater numbers of mirrors depending on configuration of the cabinet 16. Furthermore, more than a single imaging device 32 may be used in order to observe larger display surfaces. The imaging device(s) 32 may observe any of the mirrors or observe the display surface 15. In the case of multiple imaging devices 32, the imaging devices 32 may all observe different mirrors or the same mirror.

Although preferred embodiments of the present invention have been described, those of skill in the art will appreciate that variations and modifications may be made without departing from the spirit and scope thereof as defined by the appended claims.

What is claimed is:

1. A method for handling a user request in a multi-user interactive input system comprising:
in response to receiving a user request to perform an action from one user area defined on a display surface of the interactive input system, prompting for input via at least one other user area on the display surface; and
in the event that input concurring with the user request is received via the at least one other user area, performing the action.

2. The method of claim 1 further comprising in the event that non-concurring input is received, rejecting the user request.

3. The method of claim 1 wherein the prompting comprises displaying a graphic object in the at least one other user area.

4. The method of claim 3 wherein the displaying further comprises translating the graphic object from one of the user areas to at least one other user area.

5. The method of claim 3 wherein the displaying further comprises displaying a graphic object to each of the other user areas simultaneously.

6. The method of claim 3 wherein the graphic object is a button.

7. The method of claim 3 wherein the graphic object is a text box with associated text.

8. The method of claim 1 wherein the display surface is embedded in a touch table.

9. A method for handling user input in a multi-user interactive input system comprising:
displaying a graphic object indicative of a question having a single correct answer on a display surface of the interactive input system;
displaying multiple answer choices on at least two user areas defined on the display surface;
receiving at least one selection of a choice from one of the at least two users areas;
determining whether the at least one selected choice is the single correct answer; and
providing user feedback in accordance with the determining.

10. The method of claim 9 wherein the receiving comprises displaying at least one selection in proximity to the graphic object by at least one user associated with one of the at least two user areas.

11. A method of handling user input in a multi-user interactive input system comprising:
displaying on a display surface of the interactive input system a plurality of graphic objects each having a predetermined relationship with at least one respective area defined on the display surface; and
providing user feedback upon movement of one or more graphic objects to at least one respective area.

12. The method of claim 11 wherein the graphic objects are displayed at random locations on the display surface.

13. The method of claim 11 wherein the graphic objects are displayed at predetermined locations.

14. The method of claim 11 wherein the plurality of graphic objects are photos and the predetermined relationships relate to contents of the photos.

15. A method of handling user input in a multi-user interactive input system comprising:
displaying on a display surface of the interactive input system a plurality of graphic objects each having a predetermined relationship with at least one other graphic object; and
providing user feedback upon the placement by the more than one user of the graphical objects in proximity to the at least one other graphic object.

16. The method of claim 15 wherein the predetermined relationship is an alphabetic order.

17. The method of claim 15 wherein the predetermined relationship is a numeric order.

18. The method of claim 15 wherein the graphic objects are letters.

19. The method of claim 18 wherein the predetermined relationship is a correctly spelled word.

20. The method of claim 15 wherein the graphic objects are blocks with an associated value.

21. The method of claim 22 wherein the predetermined relationship is an arithmetic equation.

22. A method of handling user input in a multi-user interactive input system comprising:
displaying a first graphic object on a display surface;
displaying multiple graphic objects having a predetermined position within the first graphic object; and
providing user feedback upon placement of the multiple graphic objects, by at least one user, within the first graphic object at the predetermined position.

23. The method of claim 22 wherein the first graphic object is divided to correspond to each of the multiple graphic objects.

24. A method of managing user interaction in a multi-user interactive input system comprising:
displaying at least one graphic object in at least one user area defined on a display surface of the interactive input system; and
in response to user interactions with the at least one graphic object, limiting the interactions with the at least one graphic object to the at least one user area.

25. The method of claim 24 wherein the limiting comprises preventing the at least one graphic object from moving to at least one other user area.

26. The method of claim 24 wherein limiting comprises preventing the at least one graphic object from scaling larger than a maximum scaling value.

27. A method of managing user interaction in a multi-user interactive input system comprising:
displaying at least one graphic object on a display surface of the interactive input system; and
in the event that at least one graphic object is selected by one user, preventing at least one other user from selecting the at least one graphic object for a predetermined time period.

28. The method of claim 27 wherein preventing comprises deactivating the at least one graphic object once selected by the one user for the predetermined time period.

29. A computer readable medium embodying a computer program for handling a user request in a multi-user interactive input system, the computer program code comprising:
program code for receiving a user request to perform an action from one user area defined on a display surface of an interactive input system;
program code for prompting for input via at least one other user area on the display surface in response to receiving the user request; and
program code for performing the action in the event that input concurring with the user request is received from the at least one other user area.

30. A computer readable medium embodying a computer program for handling user input in a multi-user interactive input system, the computer program code comprising:
program code for displaying a graphic object indicative of a question having a single correct answer on a display surface of the interactive input system;
program code for displaying multiple answer choices to the question on at least two user areas defined on the display surface;
program code for receiving at least one selection of a choice from one of the at least two user areas;
program code for determining whether the at least one selected choice is the single correct answer; and
program code for providing user feedback in accordance with the determining.

31. A computer readable medium embodying a computer program for handling user input in a multi-user interactive input system, the computer program code comprising:
program code for displaying on a display surface of the interactive input system a plurality of graphic objects each having a predetermined relationship with at least one respective area defined on the display surface; and
program code for providing user feedback upon movement of one or more graphic objects to at least one respective area.

32. A computer readable medium embodying a computer program for handling user input in a multi-user interactive input system, the computer program code comprising:
program code for displaying on a display surface of the interactive input system a plurality of graphic objects each having a predetermined relationship with at least one other graphic object; and
program code for providing user feedback upon the placement by the more than one user of the graphical objects in proximity to the at least one other graphic object.

33. A computer readable medium embodying a computer program for handling user input in a multi-user interactive input system, the computer program code comprising:
program code for displaying a first graphic object on a display surface of the interactive input system;
program code for displaying multiple graphic objects having a predetermined position within the first graphic object; and
program code for providing user feedback upon placement of the multiple graphic objects, by at least one user, within the first graphic object at the predetermined position.

34. A computer readable medium embodying a computer program for managing user input in a multi-user interactive input system, the computer program code comprising:
program code for displaying at least one graphic object in at least one user area defined on a display surface of the interactive input system; and
program code for limiting the interactions with the at least one graphic object to the at least one user area in response to user interactions with the at least one graphic object.

35. A computer readable medium embodying a computer program for managing user input in a multi-user interactive input system, the computer program code comprising:
program code for displaying at least one graphic objects on a display surface of the interactive input system; and
program code for preventing at least one other user from selecting the at least one graphic object for a predetermined time period, in the event that at least one graphic object is selected by one user.

36. A multi-touch interactive input system comprising:
a display surface; and
processing structure communicating with the display surface, the processing structure being responsive to receiving a user request to perform an action from one user area defined on the display surface, prompting for input via at least one other user area on the display surface, and in the event that input concurring with the user request is received from the at least one other user area, performing the action.

37. A multi-touch interactive input system comprising:
a display surface; and
processing structure communicating with the display surface, the processing structure displaying a graphical object indicative of a question having a single correct answer on the display surface, displaying multiple answer choices to the question on at least two user areas defined on the display surface, receiving at least one selection of a choice from one of the at least two users areas, determining whether the at least one selected choice matches the single correct answer, and providing user feedback in accordance with the at least one selection.

38. A multi-touch interactive input system comprising:
a display surface; and
processing structure communicating with the display surface, the processing structure displaying on the display surface a plurality of graphic objects each having a predetermined relationship with at least one respective area defined on the display surface, and providing user feedback upon movement of one or more graphic objects to at least one respective area.

39. A multi-touch interactive input system comprising:
a display surface; and
processing structure communicating with the display surface, the processing structure displaying on the display surface a plurality of graphic objects each having a predetermined relationship with at least one other graphic object, and providing user feedback upon the placement by the more than one user of the graphical objects in proximity to the at least one other graphic object.

40. A multi-touch interactive input system comprising:
a display surface; and
processing structure communicating with the display surface, the processing structure being responsive to user interactions with at least one graphic object displayed in at least one user area defined on at display surface, to limit the interactions with the at least one graphic object to the at least one user area.

41. A multi-touch interactive input system comprising:
a display surface; and
processing structure communicating with the display surface, the processing structure being responsive to one user selecting at least one graphic object displayed in at least one user area defined on at display surface, to prevent at least one other user from selecting the at least one graphic object for a predetermined time period.
